(19) United States
(12) Patent Application Publication
(10) Pub. No.: US 2020/0020956 A1
(43) Pub. Date: Jan. 16, 2020

(54) CHANNEL FORMING SYSTEM OF FUEL CELL SEPARATOR

(71) Applicant: J&L Tech Co., Ltd., Ansan-si (KR)

(72) Inventors: Youngha JUN, Seoul (KR); Ki Ho YEO, Siheung-si (KR)

(73) Assignee: J&L Tech Co., Ltd., Ansan-si (KR)

(21) Appl. No.: 16/427,683

(22) Filed: May 31, 2019

(30) Foreign Application Priority Data
Jul. 16, 2018 (KR) 10-2018-0082598
Dec. 12, 2018 (KR) 10-2018-0160150

(51) Int. Cl. H01M 8/026; H01M 8/025; H01M 8/0223

(52) U.S. Cl. CPC H01M 8/026; H01M 8/0223; H01M 8/025

(57) ABSTRACT

A channel forming system of fuel cell separator is provided. The channel forming system includes a composite molded body of graphite or graphite and resin that comprises the fuel cell separator; and a channel forming tool with rotary drive for the composite molded body. The channel forming tool includes a cylindrical body; and a grooving tool. The grooving tool includes machining blades in the shape of groove which are manufactured as workpiece shape of the channel and regularly arranged in lines on the external circumferential surface along the major axis of the cylindrical body, and as the channel forming tool rotates against the composite molded body, channels are created on the whole surface of one side of the composite molded body.

### CROSS-REFERENCE TO RELATED APPLICATIONS

This application claims priority to Korean Patent Application No. 10-2018-0082598 filed on Jul. 16, 2018 and Korean Patent Application No. 10-2018-0160150 filed on Dec. 12, 2018, the entire contents of which are herein incorporated by reference.

### TECHNICAL FIELD

The present invention is related to channel forming of fuel cell separator, which is specifically a technique to form channels on a fuel cell separator which is composite molded body including graphite.

### BACKGROUND

Fuel cell is a type of self power generation system that produces electricity by means of electrochemical reaction between hydrogen, oxygen, and catalyst material. As an eco-friendly energy, fuel cell can be applied to batteries of eco-friendly vehicles and used as power district generation cell as well. Hundreds of fuel cell separators are used to provide channels to electricity that are generated by means of connecting anode and cathode which constitutes fuel cell with a specific amount of generation capacity. In addition, fuel cell separator provides with path to feed base materials such as gas, liquid fuel, or oxidizing gas, which in result creating channels for them.

Conventional methods to form channels of fuel cell separators are as below.

A channel forming method using end mill moves an end mill along the shape of the channel in order for machining. As a mechanical cutting method using a machining tool, its productivity or effectiveness is low.

A fluid jet, e.g., sandblasting, is also suggested (Patent Registration 10-0545992). Specifically, after coating with dry film and exposure, the pattern is removed by dry etching (sandblasting, shot peening, ultrasonic etching, etc.) before completed by washing. This method yields low efficiency due to complicated steps of the process.

A technique of channel forming on the separator molding by means of stamping machining with a high pressure stamper is also suggested, but this method cannot be commercialized due to sand burning between stamping mold and resin in spite of its high production efficiency.

In addition, a separator forming technique using a molding with machined channels is also suggested. This method may yield high efficiency in that forming and machining are conducted simultaneously, but it is difficult to secure uniformity of products, the price of molding is too much, frequent damages of the molding costs a lot, and, especially, it cannot be applied to large-sized separators due to sand burning on the mold.

### SUMMARY

The technical goal of this invention is to provide channel forming systems of fuel cell separator with low cost, high efficiency, and mass production by overcoming the obstacles suggested above.

To achieve the goal above, this invention provides a channel forming system of fuel cell separator which enables making channels on one the whole side or one side at once by means of a machining tool that has many machining blades aligned along the longitudinal direction of separator's composite molded body of graphite or graphite and resin.

In other words, this bar-shaped machining tool in tool material (hardmetal or tool steel) is a grooving tool manufactured in a workpiece shape of the channel that is intended to be created on the separator, which enables making many channels at the same time by etching multiple grooves with its bar-shaped tool material.

The bar-shaped grooving tool above is a channel forming tool of fuel cell separator which is fixed on the side of a cylinder-shaped holder, jig, or grooving tool assembly with a length larger than the width of the separator, and transferred with contact on the surface of the separator while rotating to make many grooves simultaneously by cutting.

The cylinder-shaped tool holder on which the grooving tool and many other machining tools are fixed rotates at the speed of 2,000 to 20,000 rpm and transferred with contact on the composite molded body at the feeding speed of 50 to 200 mm/sec, creating all channels on one side of the separator within several seconds.

The shape of each channel formed above is as wide as 1.0 to 2.0 mm and as deep as 0.3 to 1.0 mm, and 100 to 200 of the grooves on the tool are made in the workpiece shape of the channel, leaving etching 100 to 200 grooves on the surface.

Based on this invention, outstanding level of mass production is available as channels can be completed on one side of a fuel cell separator within several seconds.

In addition, the channel forming system of fuel cell separator with the grooving tool of this invention enables simplified equipment and a much more streamlined process.

Furthermore, this invention is applied at room temperature and rotation of the grooving tool conducts cutting, which does not the problem of sand burning of resin on the tool as found on stamper or molding methods.

### BRIEF DESCRIPTION OF DRAWINGS

The picture of FIG. 1 shows the channel forming tool of this invention in the holder.

FIG. 2 is a magnified picture of the grooving tool of the channel forming tool in FIG. 1.

FIG. 3 shows the channel forming tool of FIG. 1 installed on the driving part and the actual picture showing how the channels are formed.

### DETAILED DESCRIPTION

The following is a detailed description of correct examples of this invention implemented referring to the attached drawings.

FIG. 1 shows how the channel forming tool (100) of this invention is located in the holder.

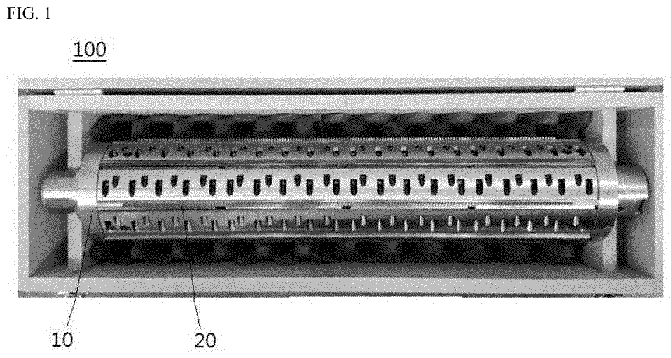

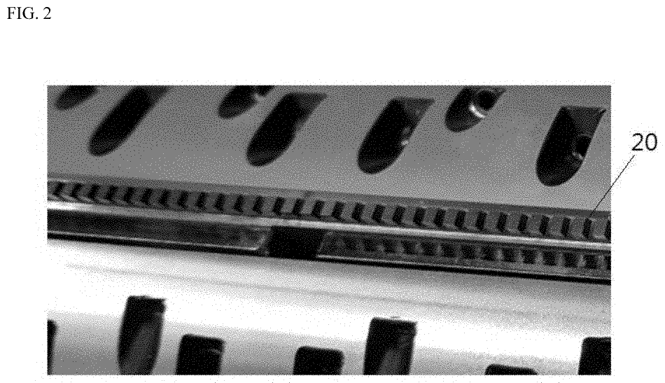

The grooving tool (20) is located along the cylindric body (10) lengthwise, and the grooving tool (20) is shown in the magnified image of FIG. 2 with more details.

The above grooving tool (20) is built with a line (linear array) with regularly aligned grooving blades along the longitudinal direction of the body, and that grooving tool (20) includes many parallel lines at certain central angles on the circumference surface. For example, lines of grooving blades located at each angle of 45 degrees orienting from the center of the cylindric body place 4 grooving blade lines on the whole surface of the body. Many grooving blade lines at regular central angles with the same orientation to center, which may make 4 to 8 lines. In the example attached, 6 lines of grooving tool (20) are made.

Taking advantage of the grooving tool which have many grooving blades regularly aligned along the composite molding body of graphite or graphite and resin that comprises the separator, channels can be formed on the whole surface or one whole side of the fuel cell separator with a run.

The above body (10) and the grooving tool (20) of the channel forming tool (100) are made of hard metal or tool metal.

The grooving tool (20) manufactured following the workpiece shape of the channels to be formed on the separator consists of an array of grooving tools, which becomes the channel forming tool of fuel cell separator that can form many channels simultaneously by creating many grooves on the bar-shaped tool material.

In other words, the grooving tool can form many channels at the same time by making bar-type lines at each certain central angles on the cylindric body (10) and creating many grooves right on the bar-type lines.

The grooving tool (20) is fixed on the circumferential surface of the cylindric body (also called as an assembly of holder, jig, or grooving tool) with a length longer than the width of the separator, and it can create many grooves simultaneously by cutting method as the body (10) is rotating and transferred with contact on the surface of the separator. Since it has multiple lines of grooving tools (20), subsequent channel cutting is carried out as the body (10) rotates and sticking of the cut material like sand burning never occurs.

The shape of each channel to be formed is as wide as 1.0 to 2.0 mm and as deep as 0.3 to 1.0 mm, and 100 to 200 of the grooves on the tool are made in the workpiece shape of the channel, leaving etching 100 to 200 grooves on the surface.

The cylindric body (10) above rotates at the speed of 2,000 to 20,000 rpm when the diameter of the bottom is 150 mm, and transferred with contact on the separator at the feeding speed of 50 to 200 mm/sec, creating all channels on one side of the separator within several seconds (in 10 seconds or less). The diameter of the bottom of the cylinder can be 100 to 200 mm.

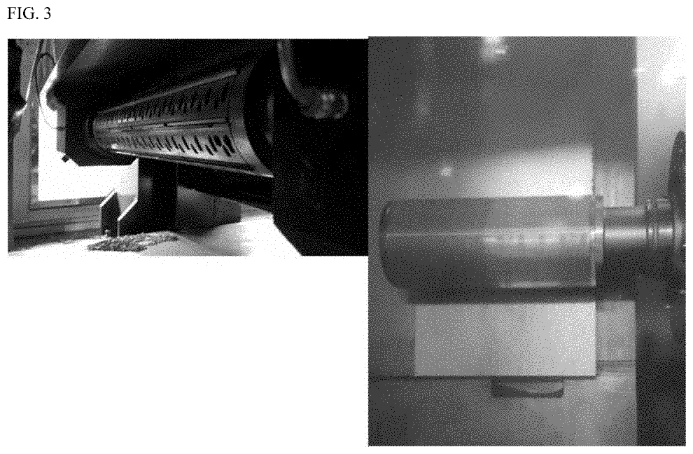

FIG. 3 shows the channel forming tool of FIG. 1 installed on the driving part and how it actually creates channels. One end of the cylindric body of the channel forming tool is fixed on the driving part to rotate the cylindric body and makes channels on the molded body of the fuel cell separator. Therefore, the construction of the equipment is simple because one single driving part is used to make channels on the whole surface of the molded body at the same time.

The actual channel forming process is carried out in the atmospheric environment of room temperature. However, it is ideal to keep the temperature constant because the composite molded body of graphite or graphite and resin is very sensitive to thermal expansion. The process can be done in a thermo-hygrostat or under controlled room temperature using an air conditioner or a heater.

The rights of this invention is defined by the scope of the claims, not limited to the examples of implementation explained above, and it is apparent that persons with ordinary skill in the art to which the invention pertain may implement various alterations and manufacturing within the scope of the rights written.

What is claimed is:

1. A channel forming system of fuel cell separator comprising:
a composite molded body of graphite or graphite and resin that comprises the fuel cell separator; and
a channel forming tool with rotary drive for the composite molded body,
wherein the channel forming tool comprises
a cylindrical body; and
a grooving tool,
wherein the grooving tool includes
machining blades in a shape of groove which are manufactured as workpiece shape of the channel and regularly arranged in lines on an external circumferential surface along a major axis of the cylindrical body, and
as the channel forming tool rotates against the composite molded body, channels are created on a whole surface of one side of the composite molded body.

2. The channel forming system of claim 1, wherein a length of a line including machining blades that comprise the grooving tool which is longer than a width of the composite molded body of the fuel cell separator.

3. The channel forming system of claim 1, wherein the lines including machining blades are located on the external circumferential surface of the cylindrical body with specific distance along a central angle.

4. The channel forming system of claim 3, wherein the cylindrical body rotates at a speed of 2,000 rpm to 20,000 rpm and is transferred with contact on the composite molded body at the feeding speed of 50 mm/sec to 200 mm/sec.

5. The channel forming system of claim 1, wherein shape of channel is formed with 1.0 mm to 2.0 mm of width and 0.3 mm to 1.0 mm of depth and the machining blades includes 100 to 200 grooves.

6. A channel forming tool of fuel cell separator comprising:
a cylindrical body; and
a grooving tool,
wherein the grooving tool includes
machining blades in a shape of groove which are manufactured as workpiece shape of the channel and regularly arranged in lines on the external circumferential surface along a major axis of the cylindrical body, and
as the channel forming tool rotates against the composite molded body, channels are created on a whole surface of one side of the composite molded body.

7. The channel forming system of claim 6, wherein the lines including machining blades are located on the external circumferential surface of the cylindrical body with specific distance along a central angle.

8. The channel forming system of claim 6, wherein shape of channel is formed with 1.0 mm to 2.0 mm of width and 0.3 mm to 1.0 mm of depth and the machining blades includes 100 to 200 grooves.
